(19) United States
(12) Patent Application Publication
(10) Pub. No.: US 2005/0207595 A1
(43) Pub. Date: Sep. 22, 2005

(54) Microphone apparatus built in computer network

(76) Inventor: Akihiro Suzuki, Hyogo (JP)

Correspondence Address: WENDEROTH, LIND & PONACK, L.L.P., 2033 K STREET N. W., SUITE 800, WASHINGTON, DC, 20006-1021, US

(21) Appl. No.: 10/499,105

(22) PCT Filed: Dec. 19, 2002
(86) PCT No.: PCT/JP02/13298

§ 371 Date: Apr. 5, 2005

(30) Foreign Application Priority Data
Dec. 21, 2001 (JP) 2001-389857

(51) Int. Cl. H04R 1/02; H04R 3/00

(52) U.S. Cl. 381/111; 381/122; 381/91

(57) ABSTRACT

A microphone device into which desired sound for broadcasting can be written through a network is provided. A microphone device 1 having a microphone element 11 for supplying a sound from a loudspeaker to a broadcasting device comprises a writable and readable storing means 15 for storing sound data transferred from a computer 3 through a computer network 2. A sound signal corresponding to the sound data read out from the storing means 15 can be supplied to the broadcasting device.

### FIELD OF THE INVENTION

The present invention relates to a microphone device incorporated into a network in order to allow users to broadcast desired sounds.

### TECHNICAL BACKGROUND

Broadcasting chimes to mark the beginning and the end of classes at school is widely known. These chimes are broadcasted by using a microphone device in a broadcasting device, and thus, it is necessary to previously store chimes generated from a sound source into a memory, such as a ROM, of the microphone device.

In this case, the problem is that chimes stored in the microphone device are so-called a fixed sound. Therefore, when a user wants to use an original sound for chimes, the user must make a ROM, in which a desired sound is stored, or provide a sound player for generating a desired chime sound. However, this increases the cost and requires additional efforts and time for creating a new chime sound.

It is, of course, possible to store multiple kinds of chime sounds on a plurality of sound ROMs or a ROM with a large capacity and to change the chimes according to the user's demands. However, this increases the cost and it is impossible to meet the demands of all the users.

### DISCLOSURE OF THE INVENTION

The present invention has been proposed to solve these problems of the prior art, and the objective of the present invention is to provide a microphone device, in which desired sounds for broadcasting can be stored via a network.

To achieve the above objective, the invention of claim 1 provides a microphone device having a microphone element for supplying a sound from a loudspeaker to a broadcasting device, comprising:
writable and readable storing means for storing sound data transferred from a computer through a computer network;
wherein said microphone device is capable of supplying a sound signal corresponding to said sound data read out from said storing means to said broadcasting device.

The invention of claim 2 is characterized in that said storing means comprises a memory having a plurality of areas, different said sound data transferred from said computer network being stored in each of said areas.

The invention of claim 3 comprises a demodulation unit for demodulating modulated said sound data transferred from said computer network in order to supply said sound data to said storing means, and for demodulating the sound data read out from said storing means in order to reproduce the original sound signal supplied to said broadcasting device.

The invention of claim 4 provides a microphone device utilized in a broadcasting system for broadcasting a sound through a network and including a microphone element for supplying a sound from a loudspeaker to a broadcasting device, comprising:
writable and readable storing means for storing sound data transferred from a computer through said network;
wherein said microphone device is capable of supplying said sound data read out from said storing means to said broadcasting system.

The invention of claim 5 is characterized in that said storing means of a microphone device set forth in claim 4 comprises a memory having a plurality of areas, different said sound data transferred from said computer network being stored in each of said areas.

The invention of claim 6 is characterized in that said sound data is a chime sound for marking the beginning and the end of the broadcasting.

In the present invention, a user creates sound data by means of a computer, transfers the sound data to storing means of a microphone device through a computer network, and stores the sound data in the storing means so as to broadcast a desired sound. The sound data stored in the storing means is read out at any appropriate time, converted to the original sound signal and broadcasted.

### BRIEF DESCRIPTION OF THE DRAWINGS

FIG. 1 illustrates an embodiment of a network system incorporating a microphone device according to the present invention.

FIG. 2 illustrates an embodiment of a microphone device according to the present invention.

FIG. 3 shows an example configuration of a flash ROM incorporated into a microphone device according to the present invention.

FIG. 4 is a flow chart diagram illustrating the operations of the network system shown in FIG. 1.

### PREFERRED EMBODIMENT OF THE INVENTION

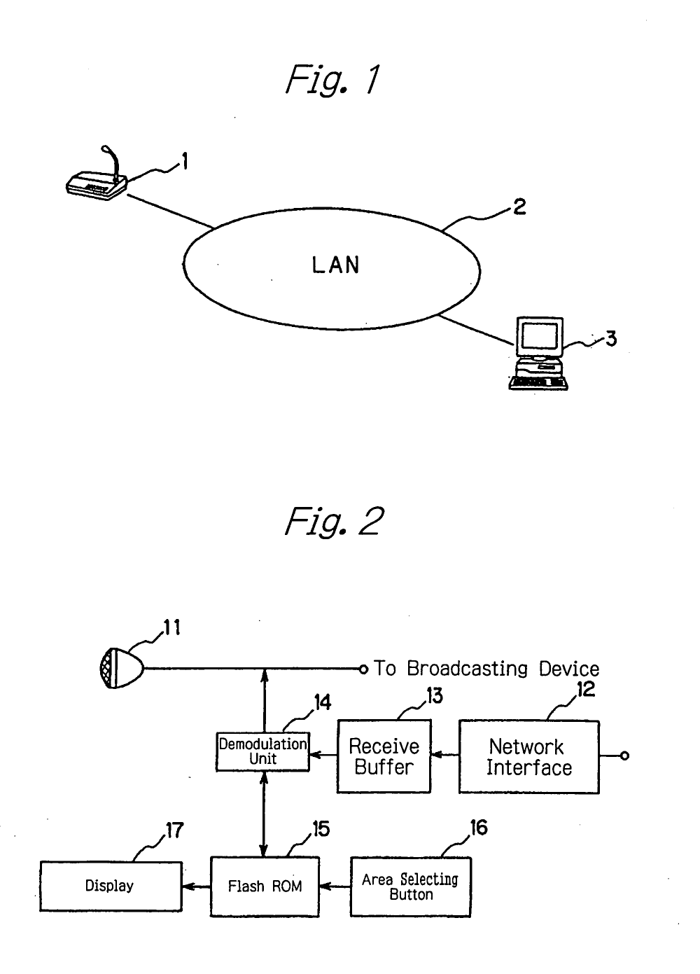

FIG. 1 illustrates an embodiment of a network system incorporating a microphone device according to the present invention. As shown in the figure, a microphone device 1 according to the present invention is connected to a personal computer 3 through a local area network (LAN) 2. That is to say, microphone device 1 is a terminal connected to local area network 2.

Preferably, a universal TCP/IP protocol is used for controlling data transmission between the microphone device 1 and the personal computer 3. In order to create desired sound data and store the sound data in a hard disk, the personal computer 3 comprises a terminal connected to an external sound source and a software for editing a sound from the sound source to desired sound data and storing the sound data.

As shown in FIG. 2, the microphone device shown in FIG. 1 comprises a microphone element 11 for supplying a sound signal for broadcasting from a loudspeaker to a broadcasting device (not shown) having an amplifier and a loudspeaker; a network interface 12 connected to the local area network 2; and a flash ROM 15 connected to the network interface 12 through a receive buffer 13 and a demodulation unit 14. An area selecting button 16 and a display 17 are connected to the flash memory 15.

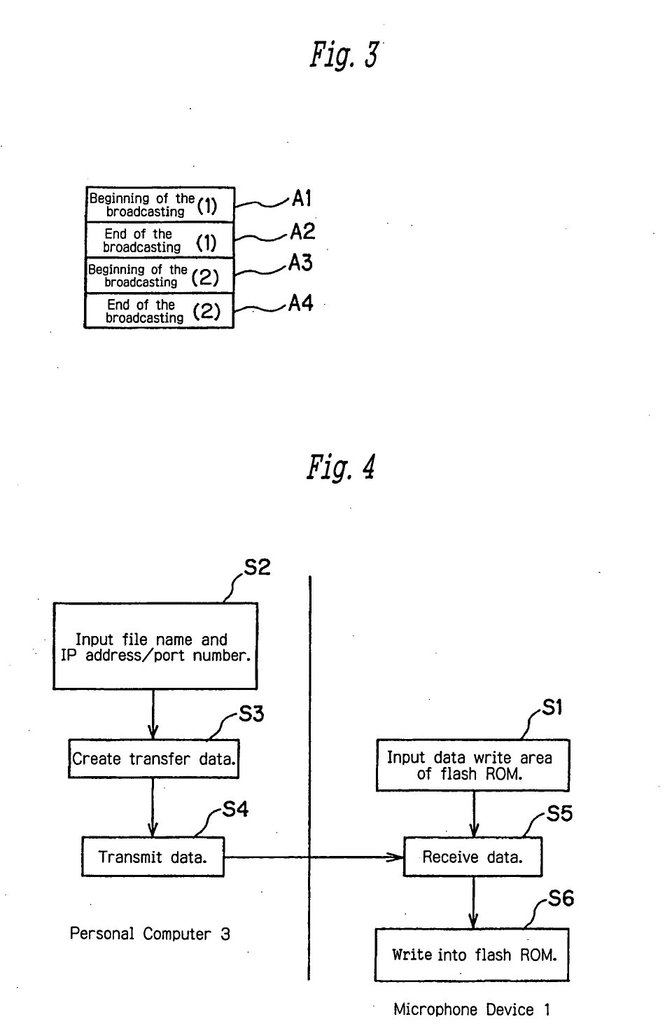

The flash ROM 15 is divided into multiple areas, and the sound data transferred from the personal computer 3 through the local area network 2 is written into any one of the multiple areas of the flash ROM 15. FIG. 3 shows the flash ROM 15 divided into four areas A1-A4, each of the areas storing sound data for reproducing different chimes. For example, Area A1 contains sound data for a chime sound, which marks the beginning of the broadcasting, with the name of “the beginning of broadcasting (1)”, and Area A2 contains sound data for another chime sound, which marks the end of the broadcasting and corresponds to the beginning of broadcasting (1), with the name of “the end of broadcasting (1)”.

In this way, the microphone device 1 is connected to the personal computer 3 through the local area network 2, and therefore, the flash ROM 15 implemented in the microphone device 1 can be rewritten by the personal computer 3. This procedure is described below in relation to FIG. 4, by showing an example procedure for writing sound data for generating a desired chime sound from the personal computer 3 to one of the multiple areas of the flash ROM 15.

First, the microphone device 1 is turned on at step S1. Once turned on, the microphone device 1 is placed in a connection acceptable state. When a user addresses an area of the flash ROM 15, that is, indicates which of the areas sound data for generating a chime sound is to be written into, the receive buffer 13 is enabled to receive the sound data from the personal computer 3, and the microphone device 1 is waiting for the data in compliance with TCP/IP protocol.

Then, at step S2, the user creates sound data for generating a desired chime sound by the personal computer 3, and stores the created sound data in a hard disk as a file. Any file format may be used for the sound data. For example, a widespread wav file format can be used.

Once the sound data are ready to be sent to the microphone device 1, at step S3, the sound file stored in the hard disk at step S1 is converted to a suitable file format for the microphone device 1 using a transfer software installed in the personal computer 3. In this step, a network address (and a port number if TCP/IP protocol is used) and the name of the sound file are designated. The suitable file format for the microphone device 1 is created, for example, by deleting a header (e.g. a wav file header information in a wav. file) that describes the file property of the sound file in order to create the sound file to be transferred. The created sound data are modulated with the Sub-Band Adaptive Differential Pulse Code Modulation (SB-ADPC), for example, and the modulated data is stored in a buffer as transfer data. A data length is inserted at the beginning of the transfer data. The transfer data stored in the buffer is transferred to the microphone device 1 having the network address designated at step S3 in accordance with the TCP/IP protocol (step S4).

The transfer data transferred from the personal computer 3 is received by the microphone device 1 at step S5, and written into the receive buffer 13 via the network interface 12. In TCP/IP protocol, if an amount of data to be transmitted is large, each portion of the data is transferred separately. The number of pieces of the received data is counted by checking the data length inserted at the beginning of each piece of the received data, and the received data is stored in the receive buffer 13.

Then, the data in the receive buffer 13 is sent to the demodulation unit 14 for demodulation so that the original sound data is reproduced. The reproduced sound data is written into the addressed area of the flash ROM 15 (step S6). Once the sound data is written, the receive buffer 13 is released, and the display 17 shows the name of the stored sound data and indicates which area of the flash ROM 15 the sound data has been written into.

In this way, a user transfers a desired chime sound created at the personal computer 3 to the microphone device 1 via the local area network 2, and stores the sound in the flash ROM 15 of the microphone device 1. Since the flash ROM 15 has multiple areas, the user can store a plurality of different chime sound data in the flash ROM 15. When the user begins broadcasting, the user selects, by means of the area selecting button 16, the area, such as A1, in which sound data for desired chime sound has been stored. Then the sound data with the name of “the beginning of broadcasting (1)” is read out from the area A1, demodulated by the demodulation unit 14 and sent to the broadcasting device so that the chime sound for marking the beginning of the broadcasting is broadcasted. The same procedure will be taken to broadcast the chime for marking the end of the broadcasting.

One embodiment of the microphone device according to the present invention has been described above, but the present invention is not limited to such an embodiment. For example, an area of the flash ROM 15 into which sound data created by the personal computer 3 is written can be designated remotely from the personal computer 3. The Internet can be used instead of the local area network 2. In this case, TCP/IP is preferably used as a network protocol because it enables data update via the Internet and improves the maintainability of the devices. However, other protocols may be used.

It is also possible to use any writable and readable storage media instead of the flash ROM 15. Further, although FIG. 1 shows a case where a microphone device and a personal computer are connected with a network, the present invention is not limited to that case but it may also contain embodiments in which a microphone device and a plurality of personal computers, a plurality of microphone devices and a personal computer, or a plurality of microphone devices and a plurality of personal computers are used.

Data written into the flash ROM 15 can be modulated data sent from a network, instead of demodulated sound data. In this case, code data is directly written into a memory so that the memory can be saved.

In addition, a microphone device according to the present invention can be used in a broadcasting system for broadcasting a sound via a network. In this application, the network of the broadcasting system can be used as a network for transferring chime sounds. This advantageously simplifies the process because no modulated sound data is necessary to be demodulated into a sound at the microphone device but sound data can be sent directly for broadcasting.

### INDUSTRIAL APPLICABILITY

As it is understood from the above explanation about one embodiment of a microphone device according to the present invention, the present invention incorporates a microphone device having a writable and readable storing means into a network, and therefore, the present invention can bring about such remarkable advantages as follows;
(1) A plurality of pieces of different sound data can be stored in the microphone device easily without using any special devices, because the present invention allows desired sound data to be created at a conventional computer, transferred to the microphone device and stored in the storing means;
(2) The present invention enables sound data to be written into the storing means of the microphone device remotely through a computer network, thereby enabling a user to easily write the sound data into the storing means; and
(3) The present invention is flexible in a case where a plurality of microphone devices are provided, because desired sound data created at the personal computer can be transferred to and written into a desired microphone device simultaneously and easily.

1. A microphone device having a microphone element for supplying a sound from a loudspeaker to a broadcasting device, comprising:
writable and readable storing means for storing sound data transferred from a computer through a computer network;
wherein said microphone device is capable of supplying a sound signal corresponding to said sound data read out from said storing means to said broadcasting device.

2. The microphone device of claim 1, wherein said storing means comprises a memory having a plurality of areas, different said sound data transferred from said computer network being stored in each of said areas.

3. The microphone device of claim 1 comprising a demodulation unit for demodulating modulated said sound data transferred from said computer network in order to supply said sound data to said storing means, and for demodulating the sound data read out from said storing means in order to reproduce the original sound signal supplied to said broadcasting device.

4. A microphone device utilized in a broadcasting system for broadcasting a sound through a network and including a microphone element for supplying a sound from a loudspeaker to a broadcasting device, comprising:
writable and readable storing means for storing sound data transferred from a computer through said network;
wherein said microphone device is capable of supplying said sound data read out from said storing means to said broadcasting system.

5. The microphone device of claim 4 wherein said storing means comprises a memory having a plurality of areas, different said sound data transferred from said computer network being stored in each of said areas.

6. The microphone device of claim 1, wherein said sound data is a chime sound for marking the beginning and the end of the broadcasting.

7. The microphone device of claim 2, wherein said sound data is a chime sound for marking the beginning and the end of the broadcasting.

8. The microphone device of claim 3, wherein said sound data is a chime sound for marking the beginning and the end of the broadcasting.

9. The microphone device of claim 4, wherein said sound data is a chime sound for marking the beginning and the end of the broadcasting.

10. The microphone device of claim 5, wherein said sound data is a chime sound for marking the beginning and the end of the broadcasting.
